(19) United States
(12) Patent Application Publication
(10) Pub. No.: US 2021/0137340 A1
(43) Pub. Date: May 13, 2021

(54) FLOOR SCRUBBER CLEANING SYTEM USING A HEAT EXCHANGER AND PRESSURE VALVE FOR CONTROLLING DISPENSING FLUID VOLUME AND TEMPERATURE

(71) Applicant: Minuteman International, Inc., Pingree Grove, IL (US)

(72) Inventors: Jonathan Sanchez, Aurora, IL (US); Dean W. Theobold, Montgomery, IL (US); John C. Peklo, Maple Park, IL (US); Christopher M. Knowlton, Pingree Grove, IL (US); John M. Hill, Naperville, IL (US)

(21) Appl. No.: 17/156,294

(22) Filed: Jan. 22, 2021

Related U.S. Application Data
(63) Continuation-in-part of application No. 16/172,817, filed on Oct. 28, 2018.

(51) Int. Cl. A47L 11/282; A47L 11/40

(52) U.S. Cl. CPC A47L 11/282; A47L 11/4088; A47L 11/4083

(57) ABSTRACT

A floor scrubber cleaning system includes a a combustion engine powered floor scrubber using at least one rotating scrubbing brush. A tank or reservoir is used for supplying a cleaning solution for cleaning a floor. A heat exchanger heats the cleaning solution flowing from the tank using hot exhaust gasses from the floor scrubber. A pressure regulator and a flow restriction orifice are used for controlling the amount of cleaning solution from the tank to the heat exchanger for controlling the volume and temperature of the cleaning solution

### FIELD OF THE INVENTION

The present invention relates generally to a system for heating cleaning solution in a floor scrubbing machine.

### BACKGROUND

Using hot water in a cleaning solution is widely accepted to enhance the process of cleaning. FIG. 1 illustrates a prior art diagram of an example of an industrial floor scrubbing machine 100 that uses one or more brushes 101 that move in a circular motion to clean the floor. In order to provide an improvement in industrial floor scrubbing effectiveness, a heated solution system has been designed for use in gasoline, diesel or liquid propane gas (LPG) powered industrial floor scrubbers. The heat source of heated cleaning solutions industrial floor scrubbers is important since manufacturers have been unsuccessful in their attempts to heat the solution being applied to the floor during scrubbing. These methods include utilizing the heat from the hydraulic system, using water from the engine cooling system, and by employing electric heaters on the machine. In all cases, there has not been enough heat energy available to heat the number of gallons per minute of solution required for the typical floor cleaning process. To be useful, the temperature of the solution must reach some threshold level to enhance the cleaning process.

Accordingly, better solutions and methods are required to better heat the cleaning solution so it may be more effective during scrubbing.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a prior art diagram showing an industrial scrubbing machine.

FIG. 2A is a block diagram illustrating a floor scrubber cleaning system for heating a cleaning solution according to a first embodiment of the invention.

FIG. 2B is a block diagram illustrating an alternative embodiment of the floor scrubber cleaning system using a recirculation tank.

FIG. 2C is a block diagram illustrating a floor scrubber cleaning system for heating a cleaning solution according to yet another alternative embodiment of the invention.

FIG. 3 is diagram illustrating the heat exchanger using in the floor scrubbing machine as used in accordance with the invention.

FIG. 4 is a cross-sectional view of the heat exchanger shown though lines IV-IV of FIG. 3.

FIG. 5 is a perspective view of a heat exchanger assembly with non-airtight cover.

FIG. 6 is diagram illustrating the heat exchanger using in the floor scrubbing machine as used in accordance with the invention.

FIG. 7 is a cross-sectional view of the heat exchanger shown though lines IV-IV of FIG. 6.

FIG. 8 is a perspective view of a heat exchanger according to an alternative embodiment of the invention.

### DETAILED DESCRIPTION

Before describing in detail embodiments that are in accordance with the present invention, it should be observed that the embodiments reside primarily in combinations of method steps and apparatus components related to a floor scrubber cleaning solution heating system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Embodiments of the present invention include a heat exchanger, which is attached to or is integral with the engine exhaust system, is used to heat the solution. Industrial floor cleaning machines typically include a cleaning solution reservoir or tank which holds a substantial amount of cleaning solution and a solution delivery system used to apply the solution in controlled amounts to the floor to be cleaned. The solution delivery system can be a gravity fed system or a pressurized system through the use of one or more pumps. One or more valves are typically used to turn on, turn off, and to control the amount of cleaning solution to the floor. Various methods are used to apply the solution to the floor. Scrubbers using one or more disk shaped scrub brushes typically deliver the solution to the center area of the brush and/or brushes. Scrubbers equipped with cylindrical shaped scrub brushes typically employ a solution delivery tube with holes spaced in a specific pattern to apply an even amount of solution to the floor in front of the scrub brushes.

FIG. 2A illustrates a cleaning system using a heat exchanger according to the various embodiments of the invention. The cleaning system 200A uses the exhaust gas 201 from a combustion motor that is directed through a muffler/catalytic converter 203. The muffler/catalytic converter 203 works to both quiet the exhaust noise but also contains a chemical catalyst for converting pollutant gases into less harmful ones. The exhaust from the muffler/catalytic converter 203 is directed to the heater exchanger 205. As described in more detail in FIG. 3, the catalytic converter 205 operates to transfer heat from one medium to another or in this case from the hot exhaust gas to a cleaning solution that is stored in the solution tank 207. Water and/or cleaning solvent that is stored in the cleaning solution tank 207 is moved from the tank through one or more valves 209. Those skilled in the art will recognize that this may be accomplished though a gravity feed type system and/or through the use of a pump like device which uses a vacuum to draw fluid from the tank 207. The cleaning fluid is moved via tubing to a heat exchanger 205. The heat exchanger 205 directs the fluid though one or more heating coils positioned in close proximity to the exhaust gasses moving though the heat exchanger 205. This enables the cleaning fluid to be sufficiently heated to some predetermined temperature e.g. 200 degrees F. As seen in FIG. 2, after moving though the heat exchanger 205, the exhaust gases from the combustion engine are vented to atmosphere using a tail pipe 206 or the like. The heated cleaning solution is then forwarded via distribution tubing to a solution delivery bar 211 and/or a spray jet where the heated cleaning solution can be used in connection with a rotating brush to clean the floor 213.

Thus, in the heating system 200, the cleaning solution flows from the solution valves into a heat exchanger then to the solution delivery bar 211 so it can be used by the scrubber brushes. The heat exchanger 205 is attached to or is an integral part of the engine exhaust pipe 202. The heat exchanger preferably is located downstream of the muffler/catalytic converter 203, or alternatively, if a catalytic converter is not required, either upstream or downstream of the muffler.

As seen in FIG. 2A, the cleaning solution will enter the top of the heat exchanger 205 at a first end where it is heated via a plurality of heat exchanger tubes. Those skilled in the art will recognize the cleaning solution as used herein may be water, a chemical cleaning solution or a combination of both. In operation, the floor scrubber cleaning system 200 can be made to provide only heated solution to the floor; or alternatively one or more additional valves can be employed to provide either heated solution or room temperature cleaning solution to the floor. A mixture of both can also be used. Moreover, by limiting the amount of cleaning solution moving through the heat exchanger 205 and/or increasing the size of the heat exchanger 205, the system can be temperature adjusted so that steam alone is used as the floor-cleaning medium. Additionally, when the solution flowing to the heat exchanger is turned off, the flow of solution from the heat exchanger also will stop. Due to residual heat in the engine exhaust system, the remaining solution in the heat exchanger will boil off to the ambient air. During that time, the resultant steam slowly exits the solution delivery tube(s) and depending on the size range tubes in the heat exchanger, the remaining fluid will be all be evaporated within approximately 5 minutes.

FIG. 2B is a block diagram illustrating an alternative embodiment of the floor scrubber cleaning system using a recirculation tank. The cleaning system 200B uses the exhaust gas 201 from a combustion motor that is directed to a head exchanger 205 which then directs the exhaust gas through a muffler/catalytic converter 203. As noted herein, the muffler/catalytic converter 203 works to quiet the exhaust noise but also contains a chemical catalyst for converting pollutant gases into less harmful gasses vented to the atmosphere.

In this embodiment, the heat is removed from the exhaust gas in the heat exchanger 205. Solution form tank 207 passes though pump 215 and valve 209 where it runs through the heat exchanger 205. As described herein, the heat exchanger 205 transfer heat to the cleaning solution where it then is routed to a diverter valve 213. The diverter value either directs the fluid back to the solution tank 207 or to a solution delivery bar 211. Those skilled in the art will recognize that this embodiment can better heat the solution since it can be continually recirculated though the heat exchanger until it is needed for cleaning. Thus, the enhanced embodiment shown in FIG. 2B involves recirculating the water or other cleaning solution back into the solution tank 207 so that the cleaning process can start with warm or hot water. The processes and method used in this embodiment. allow water on the floor to be much hotter and more effective for cleaning. The process includes the steps of:
1) Filling solution tank with tap water or other cleaning solution;
2) Operating the cleaning system in a recirculation mode so the solution can be continually heated and put back into the solution tank; and
3) Operating the cleaning system for approximately 10-15 minutes until the water is 85-90 degrees F.; and
4) Switching the cleaning system from the recirculation mode to a delivery mode allowing cleaning solution to escape though the delivery bar.

With regard to FIG. 2A and FIG. 2B, the cleaning system 200A can operate in two ways. It can draw water from the solution tank reservoir 207, heat it through the heat exchanger 205 and then deposit it to the floor via the delivery bar 211. Alternatively, the cleaning system 200B can draw water from the solution tank reservoir 207, heated through the heat exchanger 205 and then recirculated back into the solution reservoir 207. This recirculated water is continually heated through the heat exchanger 205, and deposited back into the solution tank reservoir 207 for some desired period. This process produces a higher temperature for the cleaning solution before dispensing it to the floor. This enables the cleaning process to more effective as the higher solution temperatures may remove dirt from soiled surfaces.

FIG. 2C is a block diagram illustrating a floor scrubber cleaning system for heating a cleaning solution according to yet another alternative embodiment of the invention. The cleaning system 200C uses the exhaust gas 201 from a combustion motor which is directed to a head exchanger 205. As in the other embodiments, the exhaust gas is directed through a muffler/catalytic converter 203. As noted herein, the muffler/catalytic converter 203 works to quiet the exhaust noise but also contains a chemical catalyst for converting pollutant gases into less harmful gasses vented to the atmosphere.

In this embodiment, water is fed from solution tank 207 view a water pump 215. The water pump 215 is electrically powered and operates at approximately at 60 lbs/sq-in (psi) to supply solution at approximately 1.6 gallons per minute (GPM) from the solution tank 207. In order to control flow, a regulation control system 216 is used. The regulation control system 216 is comprised for a pressure regulation 217 which controls pressure from the water pump 215 to a flow restrictor orifice 219. The flow restrictor orifice 219 allows the flow of cleaning solution to be finely regulated before passing downstream to a two-way solenoid 221. The two-way solenoid is electrically operated which turns the flow of solution on or off to the heat exchanger 205. As noted herein, when the solenoid valve is on, cleaning solution passes through the heat exchanger 205 where it is heated to some predetermined temperature before passing downstream to a spray bar 211. Thus, in situations where higher temperatures of cleaning solution are needed, the flow can be slowed to the cleaning solution passes though the heat exchanger 205 more slowly so that it is heated to a higher temperature. Hence, those skilled in the art will recognize that this embodiment allows both the pressure and temperature of the cleaning solution to be easily controlled before it is dispensed by the spray bar 211.

Considering the high temperatures involved an integral part of this system is user safety. An important goal in the design and development of this system is safety. The delivery system of tubes from the cleaning solution control valve(s) to the cleaning brushes, is always open to atmosphere. This ensures that no heat induced pressure built up in the heat exchanger and no heated solution or steam exiting anywhere other than the solution delivery tube(s). The heated solution and steam exit areas are located well away that those accessed by the user. Further after approximately five (5) minutes after the water is shut off, no heated solution remains in the heat exchanger or elsewhere in the system (any remaining solution having been boiled off). With the solution thus removed the remaining system is essentially no different than a typical exhaust system and does not present a temperature safety issue any different than that found on a standard exhaust system.

FIG. 3 is perspective view of the heat exchanger used in connection with the floor scrubber heating system. The heat exchanger 300 includes a coiled tube 301 forming a substantially cylindrical body or shape. Although the heat exchanger 300 is depicted being formed as a helix or helical coil, those skilled in the art will recognize that other shapes are possible e.g. square or triangular. As described herein, exhaust gases are passed though the center. Cleaning fluid such as water and/or cleaning solvent is passed though the tube 301. The heated solution then exits the top of the opposite end of the heat exchanger 300 and flows directly to the scrub brushes or delivery tube and onto the floor. Requiring the cleaning solution to enter the top of one end of the heat exchanger 300 and exit the top at the other end causes the cleaning solution to fill the heat exchanger 300 taking full advantage of the heated surface area of the heat exchanger 300. This enhances the heat exchange by extracting the maximum heat during the short time the cleaning solution is moving through the heat exchanger 300. In use, the heat exchanger 300 is sized to provide an optimal flow rate so to achieve a cleaning solution temperature in the range of 200 degrees F. Those skilled in the art will further recognize that high temperature silicon hoses are used in areas that come in contact with the heat exchanger's inlet 303 and outlet 305. As seen in FIG. 3, the cleaning solution inlet 303 and cleaning solution outlet 305 are shown elevated and/or displaced from the coiled tube 301. The cleaning solution inlet 303 works to feed all three interlaced coils forming a helix while the cleaning solution outlet 303 provides a single outlet for the heated cleaning solution once passing though the coils.

FIG. 4 is a cross-sectional view of the heat exchanger shown though lines IV-IV of FIG. 3. An issue when dealing with floor care equipment is in heating the cleaning solution to an adequate temperature. In order to provide adequate cleaning capability, enough water must be heated to provide a water flow rate of at least three gallons per minute (3 gal/min) without the build-up of steam pressure. The heat exchanger must also be small in size to fit around the exhaust system of the industrial floor scrubbing machine. Further, it is also important that the system will not build up steam-pressure. As seen in FIG. 2, this is accomplished by using a gravity feed water delivery system that is always open to atmosphere from the heat exchanger through to the water delivery tube (to the floor). In this way, even a slight and/or insignificant pressure build-up simply pushes the water out of the solution delivery tube though the solution delivery bar 211 and on to the floor 213. As seen in FIG. 4, the heat exchanger 400 uses three (3) interlaced coils of copper tubing that was positioned within a substantially rectangular container. In use, the exhaust gases pass from the engine exhaust pipe through the center of the concentric copper coils formed into a substantially cylindrical shape. Thereafter, the exhaust gas exits the out a tail pipe after heating the cleaning solution.

FIG. 5 is a perspective view of the assembled heat exchanger assembly that uses a non-airtight housing or cover. The heat exchanger assembly 500 includes a substantially rectangular cover 501 that houses the heat exchanger coil shown in FIGS. 3 and 4. The cover 501 includes support hangers 503, 505 that can work to support the heat exchanger assembly 500 at some desired location on the scrubbing machine. Although illustrated in a cylindrical configuration, support hangers 503, 505 may be any size or shape and positioned as needed on the heat exchanger assembly 500. In use, exhaust gasses that enter the inlet 507 are directed though the center and around the outer edges of the coil before the exit at the outlet 509. This in-turn heats the coil where heat is transferred to the cleaning solution entering the cleaning solution tube inlet 511 before it exits from the cleaning solution tube outlet 513. This technique eliminates any need for welding of the container which prevents future weld failures due the heat cycling of the cover 501.

FIG. 6 is perspective view of the heat exchanger used in connection with the floor scrubber heating system. The heat exchanger 600 includes a coiled tube 601 forming a substantially cylindrical body or shape. Although the heat exchanger 300 is depicted being formed as a helix or helical coil, those skilled in the art will recognize that other shapes are possible e.g. square or triangular shapes. As described herein, exhaust gases are passed though the center of the coil. Cleaning fluid such as water and/or cleaning solvent is passed though the tube 601 through the inlet 603. The heated solution then exits the heat exchanger 605 and flows directly to the scrub brushes or delivery tube and onto the floor. Requiring the cleaning solution to enter one end of the heat exchanger 600 and exit the same end causes the cleaning solution to fill the heat exchanger 600 taking full advantage of the heated surface area of the heat exchanger 600. This enhances the heat exchange by extracting the maximum heat during the short time the cleaning solution is moving through the heat exchanger 600. In use, the heat exchanger 600 is sized to provide an optimal flow rate so to achieve a cleaning solution temperature in the range of 200 degrees F. Those skilled in the art will further recognize that high temperature silicon hoses are used in areas that come in contact with the heat exchanger's inlet 603 and outlet 605. As seen in FIG. 6, the cleaning solution inlet 603 and cleaning solution outlet 605 are shown on the same end from the coiled tube 601. The cleaning solution inlet 603 works to feed the coils forming a helix while the cleaning solution outlet 605 provides a single outlet for the heated cleaning solution once passing though the coils.

FIG. 7 is a cross-sectional view of the heat exchanger shown though lines IV-IV of FIG. 6. An issue when dealing with floor care equipment is in heating the cleaning solution to an adequate temperature. In order to provide adequate cleaning capability, enough water must be heated to provide a water flow rate of at least three gallons per minute (3 gal/min) without the build-up of steam pressure. The heat exchanger must also be small in size to fit around the exhaust system of the industrial floor scrubbing machine. Further, it is also important that the system will not build up steam-pressure. As seen in FIG. 2, this is accomplished by using a water delivery system that is always open to atmosphere from the heat exchanger through to the water delivery tube (to the floor). In this way, even a slight and/or insignificant pressure build-up simply pushes the water out of the solution delivery tube though the solution delivery bar 211 and on to the floor 213. As seen in FIG. 7, the heat exchanger 700 uses one (1) coil of copper tubing with an inlet coil 701 leading to the outlet coil 703 that was positioned within a substantially cylindrical container. In use, the exhaust gases pass from the engine exhaust pipe through the center of the concentric copper coils formed into a substantially cylindrical shape. Thereafter, the exhaust gas exits the out a tail pipe after heating the cleaning solution.

FIG. 8 is a perspective view of the assembled heat exchanger assembly that uses an airtight housing or cover. The heat exchanger assembly 800 includes a substantially cylindrical cover 501 that houses the heat exchanger coil shown in FIGS. 6 and 7. The assembled heat exchanger 800 includes exhaust flanges 803, 805 that can work to support the heat exchanger assembly 800 at some desired location on the scrubbing machine. Exhaust flanges 803, 805 may be any size or shape and positioned as needed on the heat exchanger assembly 800. In use, exhaust gasses that enter the inlet 807 are directed though the center and around the outer edges of the coil before the exit at the outlet 809. This in-turn heats the coil where heat is transferred to the cleaning solution entering the cleaning solution tube inlet 811 before it exits from the cleaning solution tube outlet 813.

Thus, the present invention is directed to a floor scrubber cleaning system for heating a cleaning solution applied to a floor. An industrial floor scrubbing machine using a combustion engine uses one or more rotating scrubbing brushes that rotates in a circular motion to clean the floor. A tank or reservoir supplies a water-based cleaning solution to a heat exchanger. The heat exchanger is of a unique design suing a plurality of interwoven coils positioned within a non-airtight housing. The heat exchanger directly heats the cleaning solution where it can be directly applied to the floor for use by the scrubbing brush.

In the foregoing specification, specific embodiments of the present invention have been described. However, one of ordinary skill in the art appreciates that various modifications and changes can be made without departing from the scope of the present invention as set forth in the claims below.

Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A floor scrubber cleaning system comprising;
a combustion engine powered floor scrubber using at least one rotating scrubbing brush;
at least one tank for supplying a cleaning solution for cleaning a floor;
a heat exchanger for heating the cleaning solution flowing from the at least one tank using hot exhaust gasses from the floor scrubber; and
at least pressure regulator and a flow restriction orifice for controlling the amount of cleaning solution from the at least one tank to the heat exchanger for controlling the volume and temperature of the cleaning solution.

2. A floor scrubber cleaning system as in claim 1, wherein the heat exchanger is also a muffler for the combustion engine.

3. A floor scrubber system as in claim 1, wherein the cleaning solution moving through the heat exchanger is applied directly to the floor.

4. A floor scrubber heating system as in claim 1, further comprising:
a muffler/catalytic converter positioned between an engine and heat exchanger.

5. A floor scrubber cleaning system as in claim 1, further comprising:
at least one delivery bar for dispending heated floor solution onto the floor.

6. A floor scrubber cleaning system as in claim 1, wherein the at least one tank uses a gravity feed to supply the cleaning solution to the heat exchanger.

7. A floor scrubber cleaning system as in claim 1, wherein the heat exchanger uses a plurality of interwoven tubes for heating the cleaning solution moving though the plurality of tubes.

8. A floor scrubber cleaning system as in claim 1, wherein the plurality of interwoven tubes includes at least three tubes.

9. A floor scrubber cleaning system as in claim 1, wherein the heat exchanger is enclosed in a non-air tight housing.

10. A floor scrubber cleaning system for heating a cleaning solution comprising:
a powered floor scrubber using at least one scrubbing brush;
at least one tank for supplying a cleaning solution;
a muffler including a heat exchanger for heating the cleaning solution flowing from the at least one tank using hot exhaust gasses from the floor scrubber;
a flow control system for controlling the volume of cleaning solution from the at least one tank to the heat exchanger for controlling the temperature of the cleaning solution; and
wherein a heated cleaning solution is applied directly to the floor being cleaned adjacent to the at least one scrubbing brush.

11. A floor scrubber cleaning system as in claim 10, wherein the flow control system includes at least one pressure regulator and flow restriction orifice.

12. A floor scrubber cleaning system as in claim 10, wherein the floor scrubber is powered by a combustion engine.

13. A floor scrubber cleaning system as in claim 10, further comprising:
a muffler/catalytic converter positioned between the powered floor scrubber and heat exchanger.

14. A floor scrubber cleaning system as in claim 10, further comprising:
at least one delivery bar for dispending the heated floor solution onto the floor.

15. A floor scrubber cleaning system as in claim 10, wherein the at least one tank uses a gravity feed to supply the cleaning solution to the heat exchanger.

16. A floor scrubber cleaning system for heating a cleaning solution applied to a floor comprising:
a combustion engine powered floor scrubber using at least one scrubbing brush that rotates in a circular motion to clean the floor;
at least one reservoir for supplying a water-based cleaning solution;
a muffler for quieting the exhaust gases from the combustion engine;
a heat exchanger for heating the cleaning solution flowing from the at least one reservoir using hot exhaust gasses from the floor scrubber; and
wherein the volume and temperature of the cleaning solution is controlled using a regulation control system.

17. A floor scrubber cleaning system as in claim 16, wherein the regulation control system includes at least one pressure regulator vale and a restrictive orifice.

18. A floor scrubber cleaning system as in claim 16, wherein heat exchanger is integrally formed within the muffler.

19. A floor scrubber cleaning system as in claim 16, further comprising:
at least one delivery bar for dispensing the cleaning solution onto the floor.

20. A floor scrubber cleaning system as in claim 16, wherein the at least one reservoir uses gravity to supply the cleaning solution to the heat exchanger.
